(19) United States
(12) Patent Application Publication
(10) Pub. No.: US 2019/0370743 A1
(43) Pub. Date: Dec. 5, 2019

(54) METHOD FOR ACQUIRING USER INFORMATION AND RELEVANT DEVICE

(71) Applicant: CAINIAO SMART LOGISTICS HOLDING LIMITED, GRAND CAYMAN (KY)

(72) Inventors: Yun GAO, HANGZHOU (CN); Cong MU, HANGZHOU (CN)

(21) Appl. No.: 16/516,085

(22) Filed: Jul. 18, 2019

Related U.S. Application Data
(63) Continuation of application No. PCT/CN2018/072041, filed on Jan. 10, 2018.

(30) Foreign Application Priority Data
Jan. 20, 2017 (CN) 201710048865.9

(51) Int. Cl. G06Q 10/08; G06Q 50/28

(52) U.S. Cl. CPC G06Q 10/0835; G06Q 50/28; G06Q 10/0833

(57) ABSTRACT

A method for acquiring user information may include acquiring, by a first terminal, a waybill identifier and a logistics platform identifier associated with the first terminal. The method may include invoking, by the first terminal, a communications module in the first terminal and sending an information request carrying the waybill identifier and the logistics platform identifier to a logistics management server through the communications module. The method may also include receiving, by the first terminal and through the communications module, a reply message sent by the logistics management server. The reply message may carry user information corresponding to the waybill identifier and the logistics platform identifier. The first terminal is enabled to acquire the user information from the logistics management server through the built-in communications module.

### CROSS-REFERENCE TO RELATED APPLICATIONS

This application is a continuation application of International Patent Application No. PCT/CN2018/072041, filed on Jan. 10, 2018, which is based on and claims priority to the Chinese Patent Application No. 201710048865.9, filed on Jan. 20, 2017 and entitled “METHOD FOR ACQUIRING USER INFORMATION AND RELEVANT DEVICE”, the content of all of which is incorporated herein by reference in their entirety.

### TECHNICAL FIELD

This application relates to the field of Internet technology, and in particular, to a method for acquiring user information and a relevant device.

### BACKGROUND

With the development of Internet technology, Internet platforms are widely used to provide physical objects for users in their daily life. Before delivering a physical object to a user, it is typically required that a logistics waybill filled with user information should be adhered on the physical object, so that a logistics company can deliver the corresponding physical object to the user according to the user information on the logistics waybill. The physical object to be delivered to the user is subjected to a plurality of procedures in the logistics company each performed by a different person, such as transportation and sorting, which causes the user information to be easily leaked and thus results in poor security.

Therefore, it is a presently urgent problem to keep user information secret.

### SUMMARY

A technical problem to be solved by this application is to provide a method for acquiring user information and a relevant device to enable a user terminal to acquire user information from a logistics management server, without the need to print the user information on a logistics waybill, thereby achieving privacy for the user information and thus improving the security thereof.

A solution to the technical problem to be solved by this application is as follows:

This application may provide a method for acquiring user information. The method may include acquiring, by a first terminal, a waybill identifier and a logistics platform identifier associated with the first terminal. The method may include invoking, by the first terminal, a communications module in the first terminal, and sending an information request to a logistics management server through the communications module. The information request may carry the waybill identifier and the logistics platform identifier. The method may include receiving, by the first terminal and through the communications module, a reply message sent by the logistics management server. The reply message may carry the user information corresponding to the waybill identifier and the logistics platform identifier.

In some embodiments, after the receiving, by the first terminal, the reply message sent by the logistics management server, the method may further include displaying, by the first terminal, the user information.

In some embodiments, the user information may include a user number, and after the receiving, by the first terminal, the reply message sent by the logistics management server, the method may further include automatically dialing, by the first terminal, the user number or automatically sending a message to the user number.

In some embodiments, after the receiving, by the first terminal, the reply message sent by the logistics management server based on the information request, the method may further include locally storing, by the first terminal, a correlation between the waybill identifier and the user information. The method may include acquiring, by the first terminal, the waybill identifier and locally reading the user information according to the waybill identifier and the correlation.

In some embodiments, before the invoking, by the first terminal, the communications module in the first terminal, the method may further include acquiring, by the first terminal, a user account. The method may include verifying, by the first terminal, that the user account is a legal account.

In some embodiments, the acquiring, by the first terminal, the waybill identifier may include: scanning, by the first terminal, a code on a logistics waybill to obtain the waybill identifier.

In some embodiments, the user information may include the user number and/or a user address.

Some embodiments of the application provide a method for acquiring user information. The method may include receiving, by a first terminal and through a communications module in the first terminal, a delivery list sent by a logistics management server. The delivery list may include a correlation between the user information and a waybill identifier. The correlation may correspond to a logistics platform identifier associated with the first terminal. The method may include locally storing, by the first terminal, the correlation between the waybill identifier and the user information. The method may include acquiring, by the first terminal, the waybill identifier. The method may also include reading, by the first terminal, the user information according to the waybill identifier and the correlation.

In some embodiments, after the reading, by the first terminal, the user information, the method may further include displaying, by the first terminal, the user information.

In some embodiments, after the reading, by the first terminal, the user information, the method may further include automatically dialing, by the first terminal, a user number or automatically sending a message to the user number.

In some embodiments, the user information may include the user number and/or a user address.

Some embodiments of the application provide a method for acquiring user information. The method may include receiving, by a logistics management server, an information request sent by a first terminal through a communications module in the first terminal. The information request may carry a waybill identifier and a logistics platform identifier associated with the first terminal. The method may include reading, by the logistics management server, the user information corresponding to the waybill identifier and the logistics platform identifier from data stored in the logistics management server according to the waybill identifier and the logistics platform identifier. The method may include sending, by the logistics management server and through the communications module, a reply message to the first terminal. The reply message may carry the user information. In some embodiments, before the storing, the method may further comprise acquiring, by the first terminal, a user account. The method may further comprise verifying, by the first terminal, that the user account is a legal account.

In some embodiments, the information request may further carry a user account. In some embodiments, before the reading, by the logistics management server, the user information may correspond to the waybill identifier and the logistics platform identifier from the data stored in the logistics management server. The method may include verifying, by the logistics management server, that the user account is a legal account.

In some embodiments, the user information may include a user number and/or a user address.

Some embodiments provide a method for acquiring user information, including: sending, by the logistics management server and through a communications module in the first terminal, the delivery list to the first terminal. The method may include acquiring, by the logistics management server, a delivery list corresponding to a first terminal. The delivery list may include a correlation between the user information and a waybill identifier read from data stored in the logistics management server. The correlation may correspond to a logistics platform identifier associated with the first terminal. The method may include send, by the logistics management server and through a communications module in the first terminal, the delivery list to the first terminal. In some embodiments, the user information may include a user number and/or a user address.

Some embodiments provide a method for generating waybill information, including acquiring, by a logistics management apparatus, a logistics platform identifier and a waybill identifier corresponding to an e-commerce order. The method may include generating, by the logistics management apparatus, the waybill information according to the logistics platform identifier and the waybill identifier.

Some embodiments provide a printing method, including acquiring, by a second terminal, waybill information, the waybill information being generated according to a logistics platform identifier and a waybill identifier. The method may include printing, by the second terminal, a logistics waybill through a printing apparatus. In some embodiments, the waybill information is printed on the logistics waybill, user information corresponding to the waybill identifier is not printed on the logistics waybill, or concealed user information is printed on the logistics waybill.

Some embodiments provide a terminal, where the terminal may be a first terminal and may include an acquisition unit configured to acquire a waybill identifier and a logistics platform identifier associated with the first terminal. The terminal may include an invoking unit configured to invoke a communications module in the first terminal and send an information request to a logistics management server through the communications module. The information request may carry the waybill identifier and the logistics platform identifier. The terminal may include a receiving unit configured to receive, through the communications module, a reply message sent by the logistics management server. The reply message may carry user information corresponding to the waybill identifier and the logistics platform identifier.

Some embodiments provides a terminal, where the terminal is a first terminal and includes a receiving unit configured to receive, through a communications module in the first terminal, a delivery list sent by a logistics management server. The delivery list may include a correlation between user information and a waybill identifier. The correlation may correspond to a logistics platform identifier associated with the first terminal. The terminal may include a storage unit configured to locally store the correlation between the waybill identifier and the user information. The terminal may include an acquisition unit configured to acquire the waybill identifier. The terminal may include a reading unit configured to locally read the user information according to the waybill identifier and the correlation.

Some embodiments provide a logistics management server, including a receiving unit configured to receive, through a communications module in a first terminal, an information request sent by the first terminal. The information request may carry a waybill identifier and a logistics platform identifier associated with the first terminal. The logistics management server may include a reading unit configured to read user information corresponding to the waybill identifier and the logistics platform identifier from data stored in the logistics management server according to the waybill identifier and the logistics platform identifier. The logistics management server may include a sending unit configured to send a reply message to the first terminal through the communications module. The reply message may carry the user information.

Some embodiments provide a logistics management server, including an acquisition unit configured to acquire a delivery list corresponding to a first terminal. The delivery list may include a correlation between user information and a waybill identifier read from data stored in the logistics management server. The correlation may correspond to a logistics platform identifier associated with the first terminal. The logistics management server may include a sending unit configured to send the delivery list to the first terminal through a communications module in the first terminal.

Some embodiments provide a logistics management apparatus, including an acquisition unit configured to acquire a logistics platform identifier and a waybill identifier corresponding to an e-commerce order. The apparatus may include a generation unit configured to generate waybill information according to the logistics platform identifier and the waybill identifier.

Some embodiments provide a terminal, where the terminal is a second terminal, including an acquisition unit configured to acquire waybill information. The waybill information may be generated according to a logistics platform identifier and a waybill identifier. The terminal may be a printing unit configured to print a logistics waybill through a printing apparatus. In some embodiments, the waybill information may be printed on the logistics waybill, user information corresponding to the waybill identifier is not printed on the logistics waybill, or concealed user information is printed on the logistics waybill.

Some embodiments provide a terminal, where the terminal may be a first terminal and may include a receiver, a transmitter, a processor, and a communications module, where the processor is connected to the receiver and the transmitter respectively. The processor may be configured to acquire a waybill identifier and a logistics platform identifier associated with the first terminal. The transmitter may be configured to invoke the communications module and send an information request to a logistics management server through the communications module. The information request may carry the waybill identifier and the logistics platform identifier. The receiver may be configured to receive, through the communications module, a reply message sent by the logistics management server. The reply message may carry user information corresponding to the waybill identifier and the logistics platform identifier.

In some embodiments, the terminal further may include a display. In some embodiments, the processor may be further configured to display the user information on the display after the receiver receives the information reply message sent by the logistics management server.

In some embodiments, the user information may include a user number. In some embodiments, the processor may be further configured to automatically dial the user number or automatically send a short message service message to the user number after the receiver receives the information reply message sent by the logistics management server.

In some embodiments, the terminal further may include a memory. The processor may be further configured to store a correlation between the waybill identifier and the user information in the memory, acquire the waybill identifier, and read the user information from the memory according to the waybill identifier and the correlation, after the receiver receives the reply message sent by the logistics management server.

In some embodiments, the processor may be further configured to acquire a user account and verify that the user account is a legal account before the transmitter invokes the communications module.

In some embodiments, the terminal further may include a code scanner. In some embodiments, when acquiring the waybill identifier, the processor may be particularly configured to scan a code on a logistics waybill through the code scanner to obtain the waybill identifier.

In some embodiments, the user information may include the user number and/or a user address.

Some embodiments provide a terminal, where the terminal is a first terminal and includes a receiver, a memory, a processor, and a communications module, where the processor is connected to the receiver and the memory respectively. The receiver may be configured to receive, through the communications module, a delivery list sent by a logistics management server. The delivery list may include a correlation between user information and a waybill identifier. The correlation may correspond to a logistics platform identifier associated with the first terminal. The processor may be configured to store the correlation between the waybill identifier and the user information in the memory, acquire the waybill identifier, and read the user information from the memory according to the waybill identifier and the correlation.

In some embodiments, the terminal may further include a display. The processor may be further configured to display the user information on the display after reading the user information from the memory.

In some embodiments, the user information may include a user number. The processor may be further configured to automatically dial the user number or automatically send a message to the user number after reading the user information from the memory.

In some embodiments, the user information may include the user number and/or a user address.

Some embodiments provide a logistics management server, including a receiver, a transmitter, a memory, and a processor, where the processor may be connected to the receiver, the transmitter, and the memory respectively. The receiver may be configured to receive, through a communications module in a first terminal, an information request sent by the first terminal. The information request may carry a waybill identifier and a logistics platform identifier associated with the first terminal. The processor may be configured to read user information corresponding to the waybill identifier and the logistics platform identifier from the memory according to the waybill identifier and the logistics platform identifier. The transmitter may be configured to send a reply message to the first terminal through the communications module. The reply message may carry the user information.

In some embodiments, the information request may further carry a user account. In some embodiments, the processor may be further configured to verify that the user account is a legal account before reading the user information corresponding to the waybill identifier and the logistics platform identifier from the memory. In some embodiments, the user information may include a user number and/or a user address.

Some embodiments provide a logistics management server, including a transmitter, a memory, and a processor, where the processor is connected to the transmitter and the memory respectively. The processor may be configured to acquire a delivery list corresponding to a first terminal. The delivery list may include a correlation between user information and a waybill identifier read from the memory. The correlation may correspond to a logistics platform identifier associated with the first terminal. The transmitter may be configured to send the delivery list to the first terminal through a communications module in the first terminal. In some embodiments, the user information may include a user number and/or a user address.

It can be seen from the technical solution above that in the embodiments of the application, a first terminal may acquire a waybill identifier and a logistics platform identifier associated with the first terminal, invoke a communications module in the first terminal, and send an information request that carries the waybill identifier and the logistics platform identifier to a logistics management server through the communications module. After receiving the information request, the logistics management server may send a reply message to the first terminal through the communications module. The reply message may carry user information corresponding to the waybill identifier and the logistics platform identifier. The first terminal may receive the user information. It can be seen that in the embodiments of this application, the first terminal is enabled to acquire the user information from the logistics management server through the built-in communications module, and therefore there is no need to print the user information on a logistics waybill, thereby achieving privacy for user information between different platforms and thus improving the security thereof.

Moreover, in the embodiments of this application, the first terminal may send the waybill identifier and the logistics platform identifier associated with the first terminal to the logistics management server in two data streams, so that the logistics management server can find the corresponding user information according to the waybill identifier and the logistics platform identifier. As a result, the first terminal may be either a terminal of any logistics platform or a general-purpose terminal such as a mobile phone, and can be adapted for scenarios where there are a plurality of logistics platforms.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of this application, and persons of ordinary skill in the art may still derive other drawings from these accompanying drawings.

FIG. 1 is a schematic structural diagram of a communication system according to an embodiment of this application.

FIG. 2 is a schematic diagram of a logistics waybill according to an embodiment of this application.

FIG. 3 is a flow chart of an embodiment of a method according to an embodiment of this application.

FIG. 4 is a flow chart of an embodiment of another method according to an embodiment of this application.

FIG. 5 is a flow chart of an embodiment of another method according to an embodiment of this application.

FIG. 6 is a flow chart of an embodiment of another method according to an embodiment of this application.

FIG. 7 is a block diagram of an embodiment of a device according to an embodiment of this application.

FIG. 8 is a block diagram of an embodiment of another device according to an embodiment of this application.

FIG. 9 is a block diagram of an embodiment of another device according to an embodiment of this application.

FIG. 10 is a block diagram of an embodiment of another device according to an embodiment of this application.

FIG. 11 is a block diagram of an embodiment of another device according to an embodiment of this application.

FIG. 12 is a block diagram of an embodiment of another device according to an embodiment of this application.

FIG. 13 is a block diagram of an embodiment of another device according to an embodiment of this application.

FIG. 14 is a block diagram of an embodiment of another device according to an embodiment of this application.

FIG. 15 is a block diagram of an embodiment of another device according to an embodiment of this application.

FIG. 16 is a block diagram of an embodiment of another device according to an embodiment of this application.

FIG. 17 is a block diagram of an embodiment of another device according to an embodiment of this application.

FIG. 18 is a block diagram of an embodiment of another device according to an embodiment of this application.

### DETAILED DESCRIPTION OF THE INVENTION

To make persons skilled in the art better understand the technical solutions of this application, the technical solutions in the embodiments of this application are clearly and completely described in the following with reference to the accompanying drawings in the embodiments of this application. Apparently, the embodiments to be described are merely a part rather than all of the embodiments of this application. All other embodiments obtained by persons of ordinary skill in the art based on the embodiments of the present invention without creative efforts shall fall within the protection scope of the present invention.

After a user has bought a physical object on an e-commerce platform, it is typically required that a logistics waybill filled with user information such as a user number (e.g., a mobile phone number or a landline telephone number) and a user address should be adhered on the physical object, so that a logistics company can deliver the corresponding physical object to the user according to the user information such as the user number and the user address on the logistics waybill. For example, a deliveryman of the logistics company delivers a commodity bought by the user on the e-commerce platform to a location corresponding to the user address and informs the user through the user number.

The physical object to be delivered to the user is subjected to a plurality of procedures in the logistics company each performed by a different person, such as transportation and sorting, which causes the user information to be easily leaked and thus results in poor security. At present, many lawbreakers steal user information for phone frauds, information reselling, etc. As a result, consumers and the society are paying more and more attention to keeping user information secret such as a user number and a user address. Therefore, it is a presently urgent problem to keep user information secret.

A currently employed solution is printing a QR code on a logistics waybill and incorporating user information into the QR code. During transportation, a deliveryman scans the QR code using a user terminal which decodes the QR code to obtain the user information. However, the user information contained in the QR code still suffers from a problem of lower security since the QR code may be easily cracked.

Another solution is applied to e-commerce platforms with self-run logistics. In this solution, user information is not printed on a logistics waybill, every deliveryman is equipped with a special-purpose apparatus of the e-commerce platform which enables the deliveryman to acquire the user information from a private database of the e-commerce platform. However, this approach is costly since every deliveryman is to be equipped with a dedicated apparatus. In addition, this approach suffers from great restrictions in application. In fact, there are a variety of logistics companies; different logistics companies use different logistics platforms; the logistics platforms used by the logistics companies do not store user information for the sake of security, but instead the user information related to the different logistics companies are stored and managed by third-party logistics management platforms (e.g., Cainiao platforms); and these logistics platforms cannot directly exchange data with management platforms.

Therefore, it is a presently urgent problem to keep user information secret in the context of a variety of logistics platforms.

To make persons skilled in the art better understand the technical solutions of this application, the technical solutions in the embodiments of this application are clearly and completely described in the following with reference to the accompanying drawings in the embodiments of this application. Apparently, the embodiments to be described are merely a part rather than all of the embodiments of this application. All other embodiments obtained by persons of ordinary skill in the art based on the embodiments of the present invention without creative efforts shall fall within the protection scope of the present invention.

A technical problem to be solved by this application is to provide a method for acquiring user information and a relevant device to enable a user terminal to acquire user information from a logistics management server, without the need to print the user information on a logistics waybill, thereby achieving privacy for the user information and thus improving the security thereof. Moreover, in the embodiments of this application, a deliveryman is allowed to use a terminal of any logistics company or a terminal provided by himself/herself, thus achieving suitability for a wider range of scenarios.

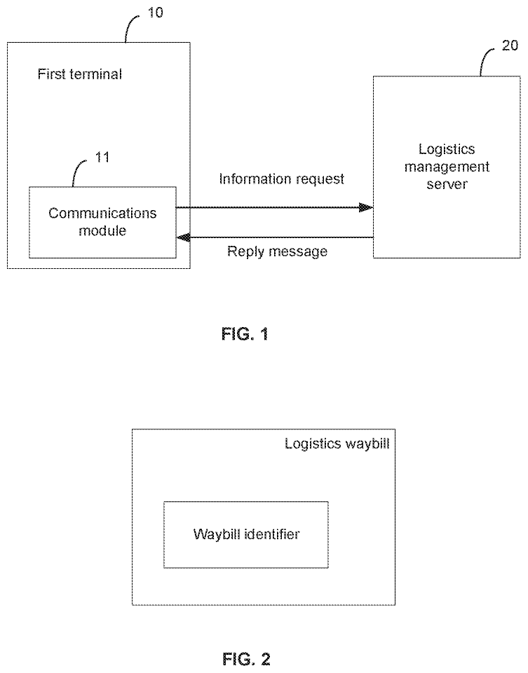

FIG. 1 illustrates a user terminal and a logistics management server involved in an embodiment of the application. A first terminal 10 is a mobile terminal used by a deliveryman during delivery, in particular a mobile phone, a tablet or a personal digital assistant (PDA), etc. A logistics management server 20 is a server of a third-party logistics management platform, e.g., a server of a Cainiao platform. An application developed by a logistics company may be installed on the first terminal 10, and the application can build a communications module 11 in the first terminal 10 by invoking a communication interface provided by the logistics management platform. Particularly, the communications module 11 is a software development kit (SDK) module, and the logistics management server 20 may be a cloud server.

In some embodiments, an e-commerce platform generates an electronic order identifier according to a user request, and the electronic order identifier and user information are provided to the third-party logistics management platform by the e-commerce platform or a seller. The logistics management platform acquires the electronic order identifier and generates a corresponding waybill identifier through a logistics platform corresponding to a merchant. For example, if the merchant uses YTO Express, the management platform generates a waybill identifier of YTO Express. The logistics management platform stores the generated waybill identifier, a logistics platform identifier, and the user information in the logistics management server 20 respectively, the logistics platform identifier being used to identify a corresponding logistics platform (different logistics companies use different logistics platforms). The seller or the logistics company may print a logistics waybill as shown in FIG. 2. Both the waybill identifier and the logistics platform identifier may be printed on the logistics waybill. There is no need to print the user information such as a mobile phone number or a user address of the user on the logistics waybill. Alternatively, concealed user information may be printed on the logistics waybill (i.e., coded information or incomplete information). It should be noted that, the embodiment of this application may only keep a user number secret such as a mobile phone number, or may only keep a user address secret, or keep various user information secret such as the mobile phone number and the user address simultaneously. In keeping the user address secret, it is a common practice to keep a lower level part of the user address secret, for example a fifth level part (i.e., a house number).

During delivery, the deliveryman may scan the waybill identifier on the logistics waybill using the first terminal 10 to obtain the waybill identifier. The first terminal 10 may verify whether the user logs in to a legal user account. If so, the communications module 11 in the first terminal 10 is invoked, and an information request is sent to the logistics management server 20 through the communications module 11. The information request may carry the waybill identifier, the logistics platform identifier, and the user account. The first terminal 10 may be a terminal registered by a certain logistics platform. The first terminal 10 locally stores the corresponding logistics platform identifier, and the first terminal 10 locally acquires the logistics platform identifier. Alternatively, the logistics platform identifier is written or printed on the logistics waybill, and the first terminal 10 may also acquire the logistics platform identifier from the logistics waybill.

When the deliveryman registers a user account using the first terminal 10, the first terminal 10 synchronously sends the registered user account to the logistics management server 20 using the communications module 11. Accordingly, the logistics management server 20 can further verify whether the user account carried in the information request is a legal user account. If so, the logistics management server reads the user information corresponding to the waybill identifier and the logistics platform identifier from data stored in the logistics management server 20 according to the waybill identifier carried in the information request, and sends a reply message to the first terminal 10 using the communications module 11. The reply message may carry the user information corresponding to the waybill identifier and the logistics platform identifier read by the logistics management server 20. The first terminal 10 may either display the user information to the deliveryman, for example, a user number such as a mobile phone number of the user, or automatically dial the user number or send a message in the form of a message template to the user number. If the first terminal 10 or the logistics management server 20 verifies that the user does not log in to a legal user account, a prompt requiring the user to log in to the legal user account is presented, or an alarm is sounded, etc. The deliveryman may also use the first terminal 10 to acquire a delivery list from the logistics management server 20 prior to delivery. A specific acquisition process includes the deliveryman acquiring one or more waybill identifiers through code scanning using a terminal such as a PDA. The terminal such as the PDA sends the waybill identifiers and a logistics platform identifier obtained through the code scanning to the logistics management server 20. The logistics management server 20 generates the delivery list according to the waybill identifiers and the logistics platform identifier obtained through the code scanning, where the delivery list includes a correlation between the waybill identifiers and user information locally read by the logistics management server 20. The correlation may correspond to the logistics platform identifier. The logistics management server 20 sends the generated delivery list to the first terminal 10, and the first terminal 10 locally stores the received delivery list. During delivery, the deliveryman may acquire the corresponding user information from the locally stored delivery list using the first terminal 10, thus ensuring that the user information can be acquired in real time even if the terminal is off-line. When acquisition of the user information locally stored in the first terminal 10 fails, the user information may be acquired in real time from the logistics management server 20 through the communications module 11.

In some embodiments, the first terminal is enabled to acquire the user information from the logistics management server through the built-in communications module, and therefore there is no need to print the user information on a logistics waybill, thereby achieving privacy for user information between different platforms and thus improving the security thereof.

In some embodiments, the first terminal 10 is enabled to acquire the user information from the logistics management server 20 through the built-in communications module 11, and therefore there is no need to print the user information on a logistics waybill, thereby achieving privacy for user information and thus improving the security thereof. Moreover, in the embodiments of this application, a deliveryman is allowed to use a terminal of any logistics company or a terminal provided by the deliveryman, thus achieving suitability for a wider range of scenarios. Additionally, in the embodiments of this application, there is no need to add user information to a QR code, which addresses the problem of low security as a result of the fact that QR codes are easy to crack.

A method for acquiring user information according to some embodiments of the application is illustrated below.

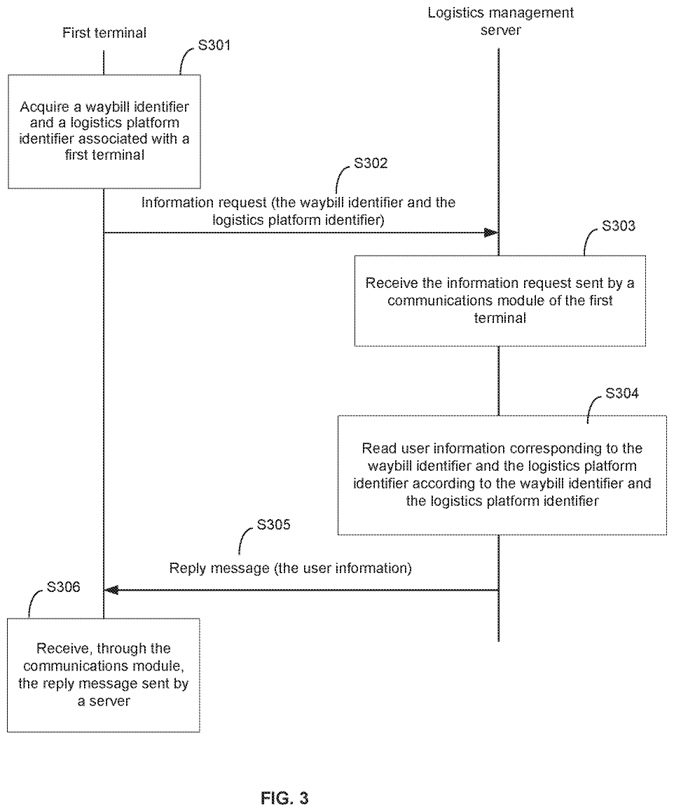

Referring to FIG. 3, a method for acquiring user information according to some embodiments of this application includes operations S301-S306.

At S301, a first terminal acquires a waybill identifier and a logistics platform identifier associated with the first terminal.

In some embodiments, the first terminal may be a handheld apparatus used by a deliveryman during delivery, in particular a mobile phone, a tablet, a PDA, etc.

In some embodiments, the waybill identifier refers to a unique identifier corresponding to a logistics waybill, for example, a waybill number for a logistics company. The logistics platform identifier serves to identify a logistics platform used by the logistics company, and the logistics platform identifier is associated with the first terminal. In other words, a correlation between a terminal identifier of the first terminal and the logistics platform identifier or a correlation between a user account logged in to by the first terminal and the logistics platform identifier is recorded on a related apparatus, for example, on the first terminal, on the logistics platform, or on a third-party management platform.

In some embodiments, the first terminal may either scan a code such as a QR code on the logistics waybill using a code-scanning device such as a camera to obtain the waybill identifier, or acquire a waybill identifier manually input by a user. The user information may not be printed on the logistics waybill, or concealed user information, including coded information or incomplete information, may be printed on the logistics waybill.

In some embodiments, the first terminal may be a terminal registered by a certain logistics platform, and therefore the first terminal locally stores the corresponding logistics platform identifier, and the first terminal locally acquires the logistics platform identifier. Alternatively, the logistics platform identifier is written or printed on the logistics waybill, and the first terminal may also acquire the logistics platform identifier by scanning a code on the logistics waybill.

At S302, the first terminal invokes a communications module in the first terminal and sends an information request to a logistics management server through the communications module. The information request may carry the waybill identifier and the logistics platform identifier.

In the embodiment of this application, the logistics management server may be a third-party management platform, for example, a server of a Cainiao platform.

Particularly, the communications module may in particular be an SDK module in the first terminal. In particular, an application developed by a logistics company may be installed on the first terminal, and the application can build the communications module of the logistics management server in the first terminal by invoking a communication interface provided by the management platform. The logistics management server may be a cloud server.

At S303, the logistics management server receives the information request sent by the first terminal through the communications module in the first terminal.

At S304, the logistics management server reads the user information corresponding to the waybill identifier and the logistics platform identifier from data stored in the logistics management server according to the waybill identifier and the logistics platform identifier.

Correlations between waybill identifiers and user information for different logistics platforms are stored in the logistics management server. Therefore the logistics management server determines a corresponding logistics platform according to a logistics platform identifier, and read user information corresponding to a waybill identifier carried in the information request according to all the correlations for the logistics platforms.

The user information may include a user number and/or a user address. The user number includes a mobile phone number or a landline telephone number of the user.

At S305, the logistics management server sends a reply message carrying the user information to the first terminal through the communications module.

At S306, the first terminal receives, through the communications module, the reply message sent by the logistics management server.

After the first terminal receives the reply message, the first terminal may display the user information carried in the reply message, for example, a user number and/or a user address. Alternatively, when the user information includes a user number, the first terminal may not display the user information, but may instead automatically dial the user number or automatically send a message to the user number. This not only simplifies a user operation, but also improves privacy for the user information.

It can be seen from the technical solution above that in the embodiments of this application, a first terminal acquires a waybill identifier and a logistics platform identifier associated with the first terminal, invokes a communications module in the first terminal and sends an information request that carries the waybill identifier and the logistics platform identifier to a logistics management server through the communications module. After receiving the information request, the logistics management server sends a reply message to the first terminal through the communications module. The reply message may carry user information corresponding to the waybill identifier and the logistics platform identifier, and the first terminal may receive the user information. It can be seen that in the embodiments of this application, the first terminal is enabled to acquire the user information from the logistics management server through the built-in communications module, and therefore there is no need to print the user information on a logistics waybill, thereby achieving privacy for user information between different platforms and thus improving the security thereof.

Moreover, in the embodiments of this application, the first terminal sends the waybill identifier and the logistics platform identifier associated with the first terminal to the logistics management server in two data streams, so that the logistics management server can find the corresponding user information according to the waybill identifier and the logistics platform identifier. As a result, the first terminal may be either a terminal of any logistics platform or a general-purpose terminal such as a mobile phone, and can be adapted for scenarios where there are a plurality of logistics platforms. Additionally, in the embodiments of this application, there is no need to add user information to a QR code, which addresses the problem of low security as a result of the fact that QR codes are easy to crack.

In some embodiments, the first terminal may be a user terminal of a first platform, and the communications module and the logistics management server may be servers of a second platform. Therefore, the deliveryman may use the user terminal of the first platform or a user terminal provided by himself/herself to interact with the logistics management server of the second platform, as long as the communications module of the second platform is in the first terminal, thus eliminating the need for a dedicated apparatus, reducing costs, and facilitating promotion and application.

In some embodiments, after the first terminal receives the reply message from the logistics management server based on the information request, the first terminal may also locally store a correlation between the waybill identifier and the user information, so that the first terminal can read the user information according to the waybill identifier and the correlation after the waybill identifier is manually input by the user or acquired through code scanning.

In some embodiments, the user account entered by the user may be verified using either the first terminal or the logistics management server, and the user account may be verified simultaneously using both the first terminal and the logistics management server. In particular, before the first terminal invokes the communications module in the first terminal, the method further includes: acquiring, by the first terminal, a user account, and verifying, by the first terminal, that the user account is a legal account. Alternatively, the information request further carries a user account. Before reading, by the logistics management server, the user information corresponding to the waybill identifier and the logistics platform identifier from the data stored in the logistics management server, the method further includes: verifying, by the logistics management server, that the user account is a legal account.

In some embodiments, if the first terminal or the logistics management server verifies that the user account is an illegal account, the first terminal or the logistics management server may stop the current process, and may further provide a prompt or sound an alarm.

In some embodiments, when the first terminal and the logistics management server exchange data such as user information, the data may be encrypted before transmission, thus further ensuring security of the data.

In some embodiments, the first terminal may acquire user information from the logistics management server in real time using an information request. In practice, in some embodiments, a delivery list may also be locally stored in the first terminal, thus ensuring that user information may be acquired from the locally stored delivery list when the first terminal is off-line. A detailed description is provided below.

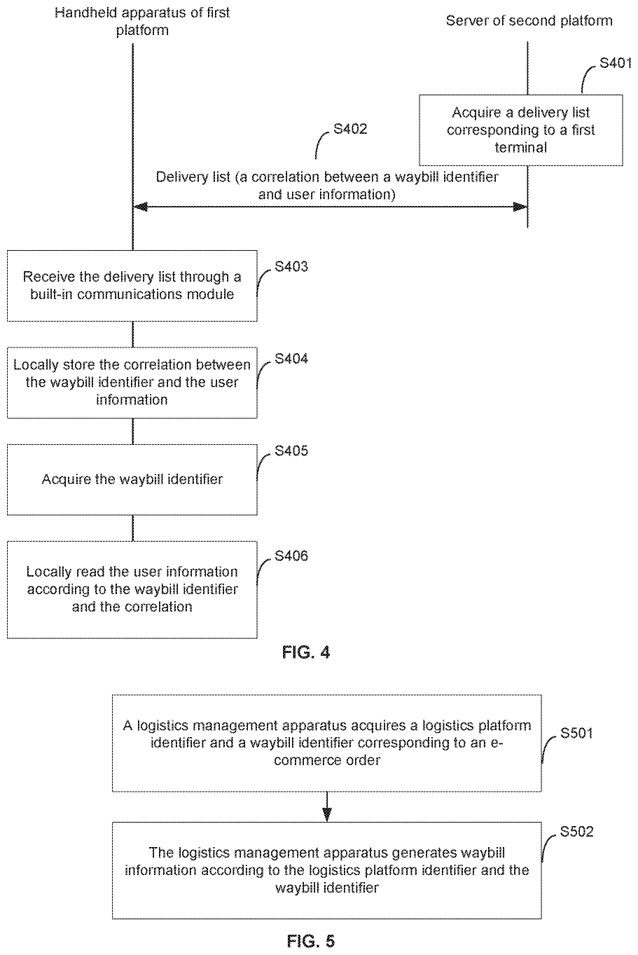

Referring to FIG. 4, it describes a method for acquiring user information according to some embodiments of this application. The method includes operations S401-S406.

At S401, a logistics management server acquires a delivery list corresponding to a first terminal. The delivery list includes a correlation between the user information and a waybill identifier read from data stored in the logistics management server. The correlation may correspond to a logistics platform identifier associated with the first terminal.

Particularly, a list of waybill identifiers, including one or more waybill identifiers, may be manually input by a user or may be obtained through code scanning. The logistics management server reads a corresponding delivery list from the data stored in the logistics management server according to the list of waybill identifiers. For example, a deliveryman obtains 5 waybill identifiers through code scanning with a terminal such as a PDA. The terminal such as the PDA sends the 5 waybill identifiers and a logistics platform identifier corresponding to the terminal such as the PDA to the logistics management server. The logistics management server reads the user information corresponding to the logistics platform identifier and the 5 waybill identifiers and generates a delivery list, including a correlation between the 5 waybill identifiers and the corresponding user information. The logistics platform identifier may also be obtained by scanning a code on a logistics waybill.

In some embodiments, the first terminal is a handheld apparatus used by a deliveryman during delivery, in particular a mobile phone, a tablet, a PDA, etc. The user information may include a user number and/or a user address. The user number may include a mobile phone number or a landline telephone number of the user. The logistics platform identifier is an identifier of a logistics platform corresponding to the first terminal.

At S402, the logistics management server sends the delivery list to the first terminal through a communications module in the first terminal.

Particularly, the communications module may be an SDK module in the first terminal. In particular, an application developed by a logistics company may be installed on the first terminal, and the application can build a communications module of a second platform in the first terminal by invoking a communication interface provided by a management platform. The logistics management server may be a cloud server.

At S403, the first terminal receives, through the communications module in the first terminal, the delivery list from the logistics management server.

In some embodiments, the first terminal may receive a delivery list corresponding to a user account sent by the logistics management server by logging in to the user account. For example, a deliveryman obtains one or more waybill identifiers through code scanning using a terminal such as a PDA. The terminal such as the PDA sends the waybill identifiers, a logistics platform identifier, and a user account logged in to during the code scanning to the logistics management server. The logistics management server reads a corresponding delivery list from data stored in the logistics management server according to the received waybill identifiers and the logistics platform identifier, and sends the corresponding delivery list to the first terminal that logs in to the user account.

At S404, the first terminal locally stores a correlation between the waybill identifier and the user information.

At S405, the first terminal acquires the waybill identifier.

In some embodiments, the first terminal acquires a waybill identifier on a logistics waybill. The first terminal may either scan a code on the logistics waybill using a code-scanning device such as a camera to obtain the waybill identifier, or acquire a waybill identifier manually input by a user. The user information may not be printed on the logistics waybill, or concealed user information may be printed on the logistics waybill. The concealed information may include coded information or incomplete information. The logistics waybill is typically adhered on a physical object to be delivered.

At S406, the first terminal locally reads the user information according to the waybill identifier and the correlation.

After the first terminal reads the user information, the first terminal may display the user information, for example, a user number and/or a user address. Alternatively, when the user information includes a user number, the first terminal may not display the user information, but instead automatically dial the user number or automatically send a message to the user number. This not only simplifies a user operation, but also improves privacy for the user information.

In some embodiments, if the first terminal fails to locally read the user information corresponding to the waybill identifier acquired in S405, the user information may be acquired in real time by sending an information request to the logistics management server. The specific process is depicted in FIG. 3.

It can be seen from the technical solution above that in some embodiments, the first terminal receives the delivery list sent by the logistics management server through the communications module in the first terminal. The delivery list may include the correlation between the user information and the waybill identifier, and the correlation corresponding to the logistics platform identifier. The first terminal locally stores the correlation. During delivery, the user information may be locally read from the first terminal when the first terminal is off-line, and therefore there is no need to print the user information on the logistics waybill, thus achieving privacy for the user information and improving security of the user information.

The correlation between the waybill identifier and the user information found by the logistics management server corresponds to the logistics platform identifier. As a result, the first terminal may be either a terminal of any logistics platform or a general-purpose terminal such as a mobile phone, and can be adapted for scenarios where there are a plurality of logistics platforms. Additionally, in some embodiments, there is no need to add user information to a QR code, which addresses the problem of low security as a result of the fact that QR codes are easy to crack.

Referring to FIG. 5 now, a method for generating waybill information is depicted according to some embodiments of this application. The method includes operations S501 and S502.

At S501, a logistics management apparatus acquires a logistics platform identifier and a waybill identifier corresponding to an e-commerce order.

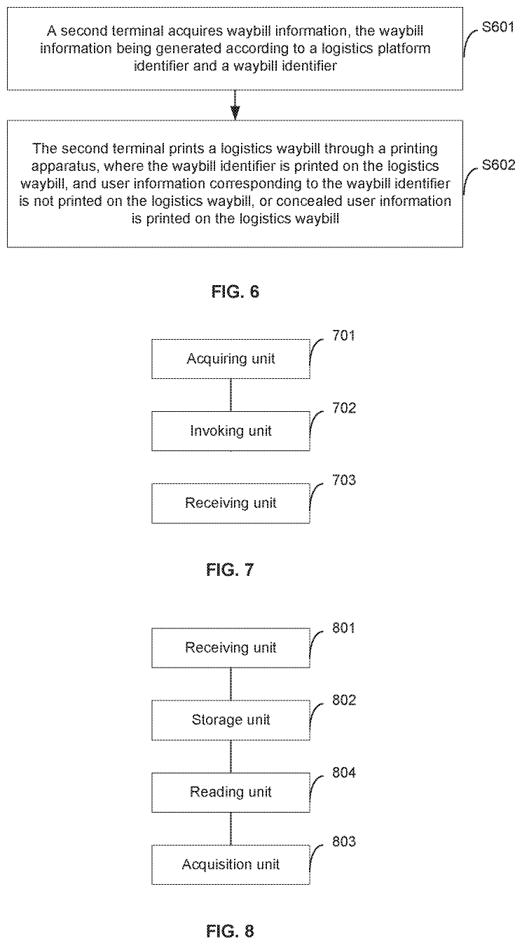

At S502, the logistics management apparatus generates the waybill information according to the logistics platform identifier and the waybill identifier. FIG. 6 further describes an embodiment of a printing method according to some embodiments of this application. The printing method includes operations S601 and S602.

At S601, a second terminal acquires waybill information, the waybill information being generated according to a logistics platform identifier and a waybill identifier;

At S602, the second terminal prints a logistics waybill through a printing apparatus.

In some embodiments, the waybill identifier is printed on the logistics waybill, and user information corresponding to the waybill identifier is not printed on the logistics waybill, or concealed user information is printed on the logistics waybill.

A detailed description of a device corresponding to some embodiments of the method above is given below.

FIG. 7 is a block diagram depicting a terminal according to some embodiments of this application. The terminal is a first terminal as described above, and may include an acquisition unit 701 configured to acquire a waybill identifier and a logistics platform identifier associated with the first terminal. The terminal may include an invoking unit 702 configured to invoke a communications module in the first terminal, and send an information request to a logistics management server through the communications module. The information request may carry the waybill identifier and the logistics platform identifier. The terminal may include a receiving unit 703 configured to receive, through the communications module, a reply message sent by the logistics management server. The reply message may carry user information corresponding to the waybill identifier and the logistics platform identifier.

FIG. 8 is a block diagram depicting a terminal according to some embodiments of this application. The terminal is a first terminal, and may include a receiving unit 801 configured to receive, through a communications module in the first terminal, a delivery list sent by a logistics management server. The delivery list may include a correlation between user information and a waybill identifier, and the correlation corresponding to a logistics platform identifier associated with the first terminal. The terminal may include a storage unit 802 configured to locally store the correlation between the waybill identifier and the user information. The terminal may include an acquisition unit 803 configured to acquire the waybill identifier. The terminal may include a reading unit 804 configured to locally read the user information according to the waybill identifier and the correlation.

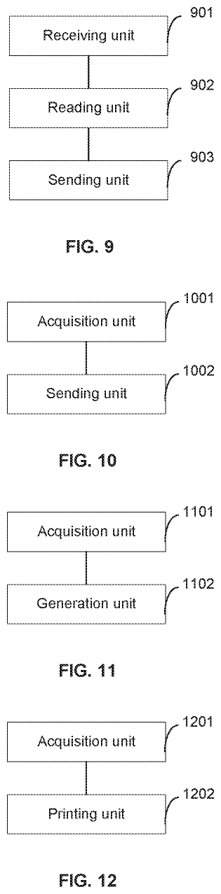

FIG. 9 is a block diagram depicting a logistics management server according to some embodiments of this application. The logistics management server may include a receiving unit 901 configured to receive, through a communications module in a first terminal, an information request sent by the first terminal. The information request may carry a waybill identifier and a logistics platform identifier associated with the first terminal. The logistics management server may include a reading unit 902 configured to read user information corresponding to the waybill identifier and the logistics platform identifier from data stored in the logistics management server according to the waybill identifier and the logistics platform identifier. The logistics management server may further include a sending unit 903 configured to send a reply message carrying the user information to the first terminal through the communications module.

FIG. 10 is a block diagram depicting a logistics management server according to some embodiments of this application. The logistics management server may include an acquisition unit 1001 configured to acquire a delivery list corresponding to a first terminal, the delivery list including a correlation between user information and a waybill identifier read from data stored in the logistics management server. The correlation may correspond to a logistics platform identifier associated with the first terminal. The logistics management server may include a sending unit 1002 configured to send the delivery list to the first terminal through a communications module in the first terminal.

FIG. 11 is a block diagram depicting another logistics management apparatus according to some embodiments of this application. The logistics management apparatus may include an acquisition unit 1101 configured to acquire a logistics platform identifier and a waybill identifier corresponding to an e-commerce order. The logistics management apparatus may include a generation unit 1102 configured to generate waybill information according to the logistics platform identifier and the waybill identifier.

Reference is now made to FIG. 12. FIG. 12 is a block diagram depicting a terminal according to some embodiments of this application. The terminal is a second terminal, and may include an acquisition unit 1201 configured to acquire waybill information, the waybill information being generated according to a logistics platform identifier and a waybill identifier. The terminal may comprise may include a printing unit 1202 configured to print a logistics waybill through a printing apparatus. In some embodiments, the waybill information is printed on the logistics waybill, user information corresponding to the waybill identifier is not printed on the logistics waybill, or concealed user information is printed on the logistics waybill.

The foregoing describes relevant devices according to the embodiments of this application from the perspective of modular functional entities. The following will describe the relevant devices according to some embodiments of this application from the perspective of hardware processing.

FIG. 13 is a block diagram of a terminal according to some embodiments of this application. The terminal is a first terminal, and may include a receiver 1301, a transmitter 1302, a processor 1303, and a communications module 1304, where the processor 1303 is connected to the receiver 1301 and the transmitter 1302.

The processor 1303 is configured to acquire a waybill identifier and a logistics platform identifier associated with the first terminal.

The transmitter 1302 is configured to invoke the communications module 1304 and send an information request to a logistics management server through the communications module. The information request may carry the waybill identifier and the logistics platform identifier.

The receiver 1301 is configured to receive, through the communications module 1304, a reply message sent by the logistics management server. The reply message may carry user information corresponding to the waybill identifier and the logistics platform identifier.

In some embodiments, the terminal may further include a display. The processor is further configured to display the user information on the display after the receiver receives the reply message sent by the logistics management server.

In some embodiments, the user information may include a user number. The processor may be further configured to automatically dial the user number or automatically send a message to the user number after the receiver receives the reply message sent by the logistics management server.

In some embodiments, the terminal further may include a memory. The processor may be further configured to store a correlation between the waybill identifier and the user information in the memory, acquire the waybill identifier, and read the user information from the memory according to the waybill identifier and the correlation, after the receiver receives the reply message sent by the logistics management server.

In some embodiments, the processor may be further configured to acquire a user account and verify that the user account is a legal account before the transmitter invokes the communications module.

In some embodiments, the terminal may further include a code scanner. In some embodiments, when acquiring the waybill identifier, the processor may be particularly configured to scan a code on a logistics waybill through the code scanner to obtain the waybill identifier.

In some embodiments, the user information may include the user number and/or a user address.

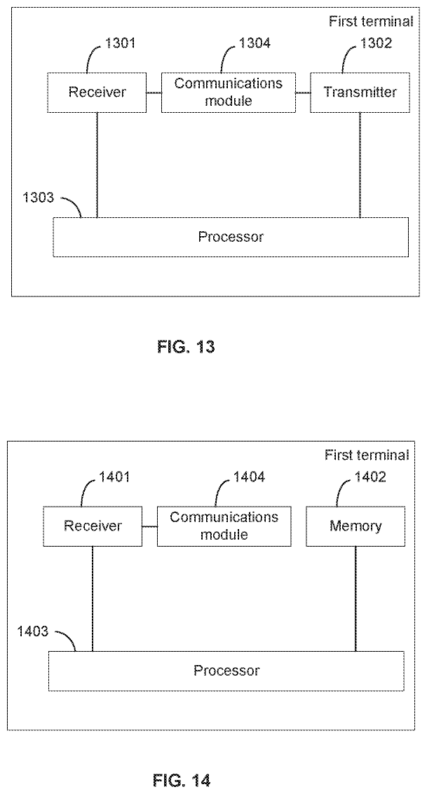

FIG. 14 is a block diagram depicting a terminal according to some embodiments of this application. The terminal is a first terminal, and may include a receiver 1401, a memory 1402, a processor 1403, and a communications module 1404, where the processor 1403 is connected to the receiver 1401 and the memory 1402.

The receiver 1401 may configured to receive, through the communications module 1404, a delivery list sent by a logistics management server. The delivery list may include a correlation between user information and a waybill identifier. The correlation may correspond to a logistics platform identifier associated with the first terminal.

The processor 1403 may be configured to store the correlation between the waybill identifier and the user information in the memory 1402, acquire the waybill identifier, and read the user information from the memory 1402 according to the waybill identifier and the correlation.

In some embodiments, the terminal further includes a display. The processor may be further configured to display the user information on the display after reading the user information from the memory.

In some embodiments, the user information may include a user number. The processor may be further configured to automatically dial the user number or automatically send a message to the user number after reading the user information from the memory. In some embodiments, the user information may include the user number and/or a user address.

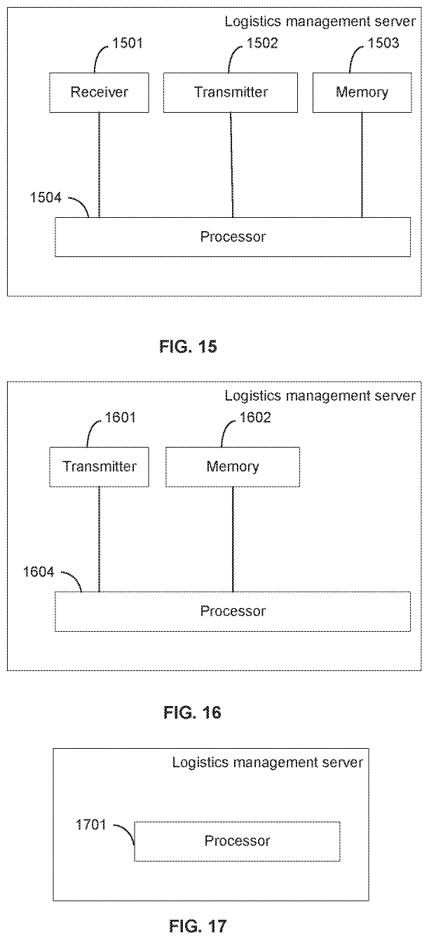

FIG. 15 is a block diagram depicting a logistics management server according to some embodiments of this application. The logistics management server may include a receiver 1501, a transmitter 1502, a memory 1503, and a processor 1504, where the processor 1504 is connected to the receiver 1501, the transmitter 1502, and the memory 1503 respectively.

The receiver 1501 may be configured to receive, through a communications module in a first terminal, an information request sent by the first terminal. The information request may carry a waybill identifier and a logistics platform identifier associated with the first terminal.

The processor 1504 may be configured to read user information corresponding to the waybill identifier and the logistics platform identifier from the memory 1503 according to the waybill identifier and the logistics platform identifier.

The transmitter 1502 is configured to send a reply message carrying the user information to the first terminal through the communications module.

In some embodiments, the information request may further carry a user account. The processor may be further configured to verify that the user account is a legal account before reading the user information corresponding to the waybill identifier and the logistics platform identifier from the memory. In some embodiments, the user information may include a user number and/or a user address.

FIG. 16 is a block diagram depicting another logistics management server according to some embodiments of this application. The logistics management server may include a transmitter 1601, a memory 1602, and a processor 1603, where the processor 1603 is connected to the transmitter 1601 and the memory 1602.

The processor 1603 may be configured to acquire a delivery list corresponding to a first terminal. The delivery list may include a correlation between user information and a waybill identifier read from the memory 1602. The correlation may correspond to a logistics platform identifier associated with the first terminal;

The transmitter 1601 is configured to send the delivery list to the first terminal through a communications module in the first terminal.

In some embodiments, the user information may include a user number and/or a user address.

FIG. 17 is a block diagram depicting a logistics management apparatus according to some embodiments of this application. The logistics management apparatus may comprise a processor 1701 configured to acquire a logistics platform identifier and a waybill identifier corresponding to an e-commerce order, and generate waybill information according to the logistics platform identifier and the waybill identifier.

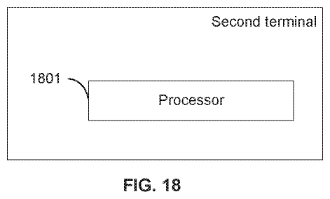

FIG. 18 is a block diagram depicting a terminal according to some embodiments of this application. The terminal is a second terminal, and may comprise a processor 1801 configured to acquire waybill information and print a logistics waybill through a printing apparatus. In some embodiments, the waybill information is generated according to a logistics platform identifier and a waybill identifier. In some embodiments, the waybill information is printed on the logistics waybill. In some embodiments, user information corresponding to the waybill identifier is not printed on the logistics waybill. In some embodiments, concealed user information is printed on the logistics waybill.

Persons skilled in the art may clearly understand that, for the purpose of convenient and brief description, for a detailed working process of the system, apparatus, and unit described above, refer to a corresponding process in the method embodiments, and details are not described herein again.

In the embodiments provided in this application, it should be understood that the disclosed system, apparatus, and method may be implemented in other manners. For example, the described apparatus embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communications connections may be implemented by using some interfaces. The indirect couplings or communications connections between the apparatuses or units may be implemented in electronic, mechanical, or other forms.

The unit as illustrated by the separation member may or may not be physically separated, the component shown as a unit may or may not be a physical unit, may be located in one place or may be distributed on multiple network units. Some or all of the units may be selected according to actual needs to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or a part of the technical solutions may be implemented in the form of a software product. The computer software product is stored in a storage medium and includes several instructions for instructing a computer device (which may be a personal computer, a logistics management server, or a network device) to perform all or some of the steps of the methods described in the embodiments of this application. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present application.

What is claimed is:

1. A method for acquiring user information, comprising:
acquiring, by a first terminal, a waybill identifier and a logistics platform identifier associated with the first terminal;
invoking, by the first terminal, a communications module in the first terminal and sending an information request to a logistics management server through the communications module, the information request carrying the waybill identifier and the logistics platform identifier; and
receiving, by the first terminal and through the communications module, a reply message sent by the logistics management server, the reply message carrying the user information corresponding to the waybill identifier and the logistics platform identifier.

2. The method according to claim 1, wherein after the receiving, by the first terminal, the reply message sent by the logistics management server, the method further comprises displaying, by the first terminal, the user information.

3. The method according to claim 1, wherein the user information comprises a user number and/or a user address.

4. The method according to claim 1, wherein after the receiving, by the first terminal, the reply message sent by the logistics management server, the method further comprises automatically dialing, by the first terminal, the user number or automatically sending, by the first terminal, a message to the user number.

5. The method according to claim 1, wherein after the receiving, by the first terminal, the reply message sent by the logistics management server based on the information request, the method further comprises:
storing, by the first terminal, a correlation between the waybill identifier and the user information; and
acquiring, by the first terminal, the waybill identifier and reading the user information according to the waybill identifier and the correlation.

6. The method according to claim 1, wherein before the invoking, by the first terminal, the communications module in the first terminal, the method further comprises:
acquiring, by the first terminal, a user account; and
verifying, by the first terminal, the user account is a legal account.

7. The method according to claim 1, wherein the acquiring, by the first terminal, the waybill identifier comprises scanning, by the first terminal, a code on a logistics waybill to obtain the waybill identifier.

8. The method according to claim 1, further comprising:
acquiring, by a second terminal, waybill information, the waybill information being generated according to a logistics platform identifier and a waybill identifier; and
printing, by the second terminal, a logistics waybill through a printing apparatus.

9. The method according to claim 8, wherein the waybill information is printed on the logistics waybill, wherein user information corresponding to the waybill identifier is not printed on the logistics waybill, and/or wherein concealed user information is printed on the logistics waybill.

10. A method for acquiring user information, comprising:
receiving, by a first terminal and through a communications module in the first terminal, a delivery list sent by a logistics management server, the delivery list comprising a correlation between the user information and a waybill identifier, the correlation corresponding to a logistics platform identifier associated with the first terminal;
storing, by the first terminal, the correlation between the waybill identifier and the user information;
acquiring, by the first terminal, the waybill identifier; and
reading, by the first terminal, the user information according to the waybill identifier and the correlation.

11. The method according to claim 10, wherein before the storing, by the first terminal, the method further comprises:
acquiring, by the first terminal, a user account; and
verifying, by the first terminal, that the user account is a legal account.

12. The method according to claim 10, wherein after the reading, by the first terminal, the user information, the method further comprises displaying, by the first terminal, the user information.

13. The method according to claim 12, wherein after the reading, by the first terminal, the user information, the method further comprises automatically dialing, by the first terminal, the user number or automatically sending, by the first terminal, a message to the user number.

14. The method according to claim 10, wherein the user information further comprises a user number and/or a user address.

15. The method according to claim 10, further comprising:
acquiring, by a second terminal, waybill information, the waybill information being generated according to a logistics platform identifier and a waybill identifier; and
printing, by the second terminal, a logistics waybill through a printing apparatus;
wherein the waybill information is printed on the logistics waybill, wherein user information corresponding to the waybill identifier is not printed on the logistics waybill, and/or wherein concealed user information is printed on the logistics waybill.

16. The method according to claim 10, further comprising:
sending, by the logistics management server and through the communication module, a reply message to the first terminal, the reply message carrying the user information.

17. A method for acquiring user information, comprising:
receiving, by a logistics management server, an information request sent by a first terminal through a communications module in the first terminal, the information request carrying a waybill identifier and a logistics platform identifier associated with the first terminal;
reading, by the logistics management server, the user information corresponding to the waybill identifier and the logistics platform identifier from data stored in the logistics management server according to the waybill identifier and the logistics platform identifier; and
sending, by the logistics management server and through the communications module, a reply message to the first terminal, the reply message carrying the user information.

18. The method according to claim 17, wherein the information request further carries a user account; and
wherein before the reading, by the logistics management server, the user information corresponding to the waybill identifier and the logistics platform identifier from the data stored in the logistics management server, the method further comprises verifying, by the logistics management server, that the user account is a legal account.

19. The method according to claim 17, wherein the user information comprises a user number and/or a user address.

20. The method according to claim 17, wherein after the reading, by the logistics management server, the user information, the method further comprises displaying the user information.
